(19) United States
(12) Patent Application Publication
(10) Pub. No.: US 2005/0271126 A1
(43) Pub. Date: Dec. 8, 2005

(54) High-speed transmission apparatus

(76) Inventors: Chen-Min Chiang, Hsinchu (TW); Li-Wei Chu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/860,141

(22) Filed: Jun. 4, 2004

(51) Int. Cl. H04B 1/38

(52) U.S. Cl. 375/219

(57) ABSTRACT

A high-speed transceiver apparatus is connected between a USB controller of a host and a peripheral device. The transceiver apparatus has a dual-port memory with a first data port and a second data port, a DMA unit providing a data transmission between the second data port and the peripheral device, and a processor controlling the data access of the dual-port memory for the peripheral device. When the USB controller of the host accesses the dual-port memory through the first data port, the processor commands the peripheral device to access the dual-port memory through the second data port. The DMA unit controls the data transmission between the dual-port memory and the peripheral device.

### FIELD OF THE INVENTION

The present invention relates to a high-speed transmission apparatus, and especially to a high-speed transmission apparatus for a USB system.

### BACKGROUND OF THE INVENTION

Current USB devices have two standards, i.e., a 1.1 version and a 2.0 version. The USB 1.1 can support a 1.5 Mbps transmission speed for a low-speed device and a 12 Mbps transmission speed for a high-speed device. However, the 12 Mbps transmission speed of USB 1.1 is not enough for video applications. The USB 2.0 issued in 2000 can enhance transmission speed to 480 Mbps, 40 times the USB 1.1 device capability, and is still compatible with USB 1.1 devices. Therefore, the USB 2.0 can be advantageously used in videoconferences, high-resolution scanners and high-capacity storage devices.

The transmission format of USB standard includes control transfer, interrupt transfer, bulk transfer and isochronous transfer. The control transfer applies the command and status between host and USB device. The interrupt transfer applies to keyboard, joystick and mouse. The bulk transfer applies to printer, scanner and storage device. The isochronous transfer applies to audio transmission.

FIG. 1 shows the block diagram of a prior art USB transceiver architecture. The host 71 (PC end) activates a token packet including IN, OUT, SETUP. These token packets are sent through a transceiver 73, which functions as an endpoint for a communication link between the host end and the device end. The transceiver 73 can be implemented by a FIFO (first-in first out) buffer. The USB transceiver architecture further comprises an arbitrator to control access to memory 77 for the host 71 or a processor 79.

During data reception through USB 1.1 or 2.0 interfaces, the data is written to the memory 77 by the transceiver 73. The transaction includes a token packet, a data packet and a handshake packet. The data packet is sent by the transceiver 73 after the token packet and then the handshake packet is sent to ensure normal transactions between host and device. The data packet is stored in an address designated by the token packet. Therefore, the processor 79 reads the token packet and stores the token packet in another location for receiving the next data packet.

The above-mentioned transaction can be normally executed with a USB 1.1 or 2.0 interface because the processor 79 has sufficient time to receive data. However, the transceiver 73 receives data at high rate such as 30 MHz/16 bits, namely, 16 bits for one cycle. The processor 79 cannot read data until the transceiver 73 receives all data (max 1024 bytes). The host 71 may need to resend data if an abnormality occurs.

### SUMMARY OF THE INVENTION

It is the object of the present invention to provide a high-speed transmission apparatus for USB system.

To achieve the above object, the present invention provides a high-speed transceiver apparatus connected between a USB controller of a host and a peripheral device, and comprises elements as follows. A dual-port memory has a first data port through which the USB controller of the host accesses data in the dual-port memory and a second data port. A DMA unit provides a data transmission between the second data port and the peripheral device. A processor controls the data access of the dual-port memory, sets the DMA unit and controls data transmission between the DMA unit and the peripheral device.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows the block diagram of a prior art USB transceiver architecture;

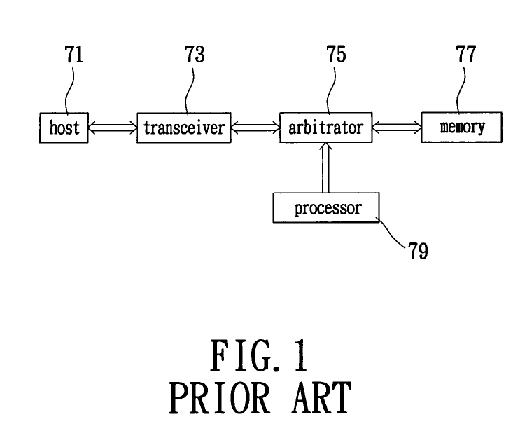

FIG. 2 shows the block diagram of the high-speed transmission apparatus according to the present invention;

FIG. 3 shows the setup of the dual-port memory according to the present invention; and

FIG. 4 shows a flowchart of the DMA transmission scheme according to the present invention.

### DETAILED DESCRIPTION OF THE INVENTION

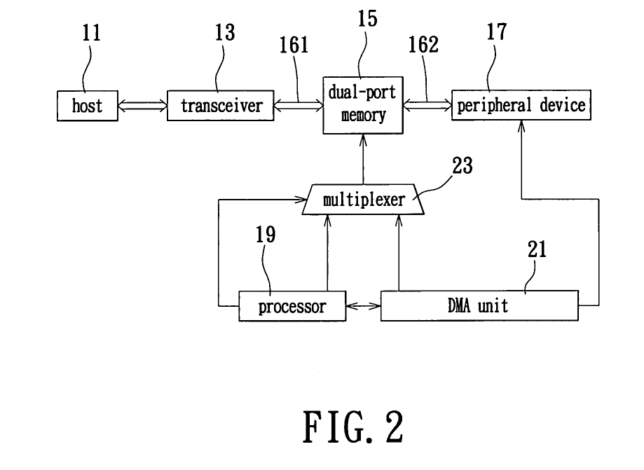

FIG. 2 shows the block diagram of the high-speed transmission apparatus according to the present invention, which is used to provide high-speed transmission between a host 11 and a peripheral device 17. The transmission apparatus comprises a transceiver 13, a dual-port memory 15, a processor 19, a DMA unit 21, and a multiplexer 23.

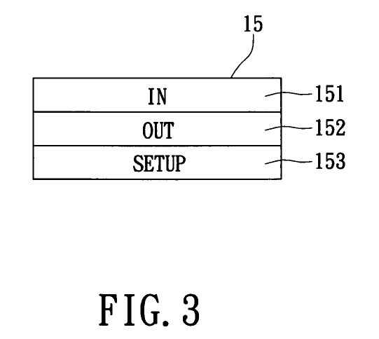

The transceiver 13 is connected between the USB controller of the host 11 and the peripheral device 17. The dual-port memory 15 comprises three sections, i.e., IN section, OUT section and SETUP section. As shown in FIG. 3, the dual-port memory 15 comprises a first FIFO 151 for receiving IN data packet, a second FIFO 152 for receiving OUT data packet, and a third FIFO 153 for receiving SETUP data packet.

The dual-port memory 15 further comprises a first data port 161 through which the host 11 can access data in the dual-port memory 15, and a second data port 162 through which the peripheral device 17 can access data in the dual-port memory 15. The dual-port memory 15 in the present invention provides a bi-directional data transmission ability such that the host 11 and the peripheral device 17 can simultaneously access data in the dual-port memory 15. In the prior art transmission apparatus, a single-port memory is used and an arbitrator is needed for controlling data transmission.

The processor 19 controls the peripheral device 17 to access data stored in the dual-port memory 15 and designated by the token packet received by the transceiver 13. It should be noted that the dual-port memory 15 has a separate, third FIFO 153 for receiving the SETUP data packet. The prior art transmission apparatus cannot simultaneously access the OUT data packet and the SETUP data packet because the OUT data packet and the SETUP data packet are placed in the same memory section. As result, the host in prior art transmission apparatus frequently needs to resend data.

In this embodiment, the DMA unit 21 is provided to accelerate the data transmission between the dual-port memory 15 and the peripheral device 17. The DMA unit 21 has different bus with the processor 19 such that the processor 19 can execute tasks other than accessing the dual-port memory 15 when the DMA unit 21 is transmitting data. The DMA unit 21 is controlled by the processor 19 to activate or pause the data transmission between the second port of the dual-port memory 15 and the peripheral device 17.

The DMA unit 21 according to the present invention comprises a plurality of registers therein, which includes address register for setting the accessing address in the dual-port memory 15, a data transfer register for setting a transfer count of the dual-port memory 15, a pause register for pausing data transmission between the dual-port memory 15 and the peripheral device 17 and recording the value of the address register and the data transfer register when pausing, and a stop register for stopping the data transmission between the dual-port memory 15 and the peripheral device 17.

The processor 19 and the DMA unit 21 can access data in the dual-port memory 15. In the present invention, the access rights to the dual-port memory 15 are determined by the multiplexer 23 for the processor 19 and the DMA unit 21. The input ends of the multiplexer 23 are connected to the processor 19 and the DMA unit 21, the output end of the multiplexer 23 is connected to the dual-port memory 15, and the selection end of the multiplexer 23 is connected to the processor 19. When the processor 19 activates the data transmission of the DMA unit 21, the access rights to the dual-port memory 15 are attributed to the DMA unit 21. After the DMA unit 21 completes the data transmission, the access rights to the dual-port memory 15 are returned to the processor 19.

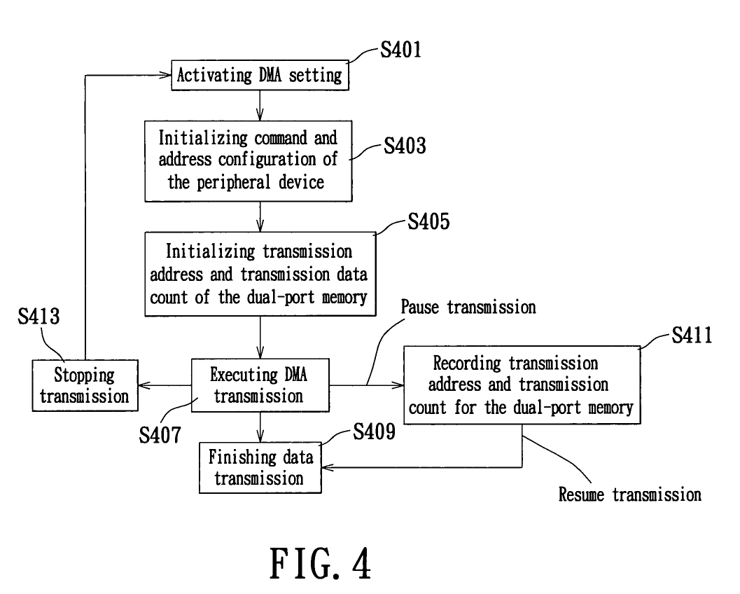

FIG. 4 shows a flowchart of the DMA transmission scheme according to the present invention. In step S401, the processor 19 activates the DMA setting. Step S403 initializes the command and address configuration of the peripheral device 17. Step S405 initializes the transmission address and transmission data count of the dual-port memory 15. Step S407 executes DMA transmission after finishing setting. When the processor 19 is to access the dual-port memory 15, which is accessed by the DMA unit 21 at that time, the processor 19 issues a pause transmission command to the DMA unit 21. In step S411 the DMA unit 21 records the transmission address and transmission count for the dual-port memory 15 such that the DMA unit 21 can resume data transmission once it regains transmission rights to the dual-port memory 15. Alternatively, in step S413, the processor 19 directly commands the DMA unit 21 to stop transmission. The DMA unit 21 subtracts one from transmission count. In step S409, data transmission is finished when the transmission count is reduced to zero.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A high-speed transceiver apparatus connected between a USB controller of a host and a peripheral device, comprising:
a dual-port memory having a first data port, wherein the USB controller of the host accesses data in the dual-port memory and a second data port through the first data port;
a DMA unit providing data transmission between the second data port and the peripheral device; and
a processor controlling data access of the dual-port memory, setting the DMA unit and controlling data transmission between the DMA unit and the peripheral device.

2. The high-speed transceiver apparatus as in claim 1, wherein the DMA unit comprises an address register for setting an accessing address in the dual-port memory.

3. The high-speed transceiver apparatus as in claim 2, wherein the DMA unit comprises a data transfer register for setting a transfer count of the dual-port memory.

4. The high-speed transceiver apparatus as in claim 3, wherein the DMA unit comprises a pause register for pausing data transmission between the dual-port memory and the peripheral device and recording values of the address register and the data transfer register.

5. The high-speed transceiver apparatus as in claim 1, wherein the DMA unit comprises a stop register for stopping data transmission between the dual-port memory and the peripheral device.

6. The high-speed transceiver apparatus as in claim 1, wherein the dual-port memory comprises a first FIFO for receiving an IN data packet, a second FIFO for receiving an OUT data packet, and a third FIFO for receiving a SETUP data packet.

7. The high-speed transceiver apparatus as in claim 1, further comprising a multiplexer with input ends connected to processor and the DMA unit, an output end connected to the dual-port memory and a selection end controlled by the processor, the processor determining access rights to the dual-port memory for either the processor or the DMA unit by setting the multiplexer.

8. The high-speed transceiver apparatus as in claim 1, further comprising a transceiver connected between the USB controller and the dual-port memory.
